(19) United States
(12) Patent Application Publication
(10) Pub. No.: US 2025/0118931 A1
(43) Pub. Date: Apr. 10, 2025

(54) SINGLE-POLE ELECTRICAL PLUG CONNECTOR SYSTEM

(71) Applicant: HARTING ELECTRIC STIFTUNG & CO. KG, Espelkamp (DE)

(72) Inventor: Sebastian GRIEPENSTROH, Lübbecke (DE)

(21) Appl. No.: 18/903,969

(22) Filed: Oct. 1, 2024

(30) Foreign Application Priority Data
Oct. 5, 2023 (DE) 102023127143.1

(51) Int. Cl. H01R 13/631; H01R 13/52

(52) U.S. Cl. CPC H01R 13/631; H01R 13/5219

(57) ABSTRACT

A single-pole plug connector system including a plug connector and a mating plug connector, wherein the plug connector has a locking shape and the mating plug connector has a locking mechanism corresponding to the locking shape, or vice versa, wherein the locking mechanism is triggered in a locking manner by a first push in the plug-in direction.

### BACKGROUND

### Technical Field

The present disclosure relates to a single-pole electrical plug connector system.

Plug connector systems of this type are required to ensure a safe electrical contact connection of implements in harsh environments, such as for lorries, or in the case of tractors and working machines in agricultural fields, woodlands, quarries, but also in industrial environments such as production halls and workshops. Plug connector systems of this type are required for heavy mobile working machines with DC-powered work units.

### Description of the Related Art

Plug connector systems for harsh environments are usually provided with dust caps. These dust caps are often provided with loss protection devices to avoid having to store them separately during use of the plug connector system and possibly becoming lost.

Alternatively, there are plug connector systems which have a spring-actuated cap which is integrated in the housing of the plug connector and/or of the mating plug connector and is automatically closed as soon as the plug connector system is not in use.

One example of plug connector systems of this type is shown in the document U.S. Pat No. 4,061,407 A, which discloses an electrical connector assembly with a plug and a socket, wherein the socket has a cover which is guided by a spring in a closed direction, the cover holding the plug in the direction of the socket in the connected state.

A disadvantage of known plug connector systems is the use of external components, such as a spring-actuated, external cover cap, or simple rubber grommets and/or plastics caps. On the one hand, these caps can become lost. On the other hand, caps of this type are quickly damaged, as a result of which their capability of protecting the components of the plug connector system from the ingress of foreign media, such as dirt, dust, fluids or similar, is logically lost.

### BRIEF SUMMARY

Embodiments of the present disclosure provide a plug connector system with a simple locking mechanism which automatically seals against foreign media. An overload safety device for such a locking mechanism is also provided.

The present disclosure is based on a single-pole plug connector system including a plug connector and a mating plug connector,

wherein the plug connector has a plug connector housing, a plug connector contact seal, and a plug connector contact element, and wherein the mating plug connector has a mating plug connector housing, a mating plug connector contact seal, a mating plug connector touch-protection device or means, and a mating plug connector contact element. The plug connector contact seal is in functional engagement with a plug connector sealing spring, and therefore the plug connector contact seal is arranged so as to be displaceable within the plug connector housing in the plug-in direction counter to a force of the plug connector sealing spring. The mating plug connector contact seal is in functional engagement with a mating plug connector sealing spring, and therefore the mating plug connector contact seal is arranged so as to be displaceable within the mating plug connector housing in the mating plug-in direction counter to a force of the mating plug connector sealing spring.

The terms “plug connector” and “mating plug connector” are selected to explain two different connectors within the plug connector system. All of the characteristics of the mating plug connector may apply to the plug connector, and vice versa, provided that a meaningful correspondence between plug connector and mating plug connector is ensured.

The “housings,” both the plug connector housing and the mating plug connector housing, are oriented to accommodate the contact elements, i.e., the plug connector contact element and the mating plug connector contact element, in them. The housings are oriented to completely surround the contact elements along their longitudinal orientation.

The term “contact element” should be understood as meaning electrically conductive elements, which can be brought together in corresponding engagement and are each connected to an electrical conductor, preferably an electrically conductive cable. In the following, terms such as “on the contact side” or “on the cable side” are used with reference to the contact elements. In this case, “on the contact side” means that side of a contact element which can be brought into electrically conductive connection with a corresponding contact element. “On the cable side” refers to the side lying opposite the “contact side,” i.e., is connected to an electrical conductor such as an electrically conductive cable.

Sealing elements which substantially seal a contact against foreign media are provided as a “contact seal.” The aforementioned contact seals interact at least with the respective housing in order to achieve the desired sealing.

The term “sealing spring” means spring elements which are designed to return the respective contact seal of the plug connector or of the mating plug connector to a designated starting position. As soon as the respective sealing spring, i.e., the plug connector sealing spring, or the mating plug connector sealing spring, is not loaded with a defined force counter to the plug-in direction (in the case of the plug connector sealing spring) or mating plug-in direction (in the case of the mating plug connector sealing spring), the sealing spring forces the corresponding contact spring in the plug-in direction, as far as the end of a housing. More specifically, the plug connector sealing spring forces the plug connector contact seal in the plug-in direction to a plug-in-side end of the plug connector housing. Here, the plug connector contact seal moved by the plug connector sealing spring seals the plug connector contact element against foreign media. In some embodiments, an approximately flush end surface may be formed at the plug-in-side end of the plug connector housing with the plug connector sealing element. Similarly, the mating plug connector sealing spring forces the mating plug connector contact seal in the mating plug-in direction to a plug-in-side end of the mating plug connector housing. The mating plug connector contact seal moved by the mating plug connector sealing spring correspondingly seals the mating plug connector contact clement against foreign media. In some embodiments, an approximately flush end surface may be formed here at the plug-in-side end of the mating plug connector housing with the mating plug connector sealing element and the mating plug connector touch-protection device or means. The plug connector sealing spring acts in the unplugged-in state of the plug connector with a force equal to or greater than 10 Newton (N), better with a force equal to or greater than 14.7 N, in some embodiments with a force equal to or greater than 30 N, alternatively with a force equal to or greater than 50 N in the plug-in direction. In order to comply with a standard against inadvertent touching, a force of 20 N is required to force the plug connector sealing element in the mating plug-in direction. In this manner, the seal remains securely closed and protects the plug connector against an undesired ingress of foreign media until a plug-in operation with a corresponding mating plug connector is initiated. Likewise, the mating plug connector sealing spring acts in the unplugged-in state of the mating plug connector with a force equal to or greater than 10 N, better with a force equal to or greater than 14.7 N, in some embodiments with a force equal to or greater than 30 N, alternatively with a force equal to or greater than 50 N in the mating plug-in direction. In order to comply with a standard against inadvertent touching, a force of 20 N is required to force the mating plug connector sealing element in the plug-in direction. By this device or means, the seal remains securely closed and protects the mating plug connector against an undesired ingress of foreign media until a plug-in operation with a corresponding plug connector is initiated.

The term “mating plug connector touch-protection device or means” primarily means a device electrically not in conductive connection with a conductive element, as a result of which no electrical connection to an operator and/or a third person is established in the event of inadvertent or even intentional touching of the mating plug connector. In some embodiments, a touch-protection device or means of this type may be produced from a non-conductive plastic. Alternatively, a non-conductive metal may also be used to provide a touch-protection device or means. A material containing rubber may also be used. Of course, combinations of the materials mentioned are conceivable, such as plastics-coated metal elements, or rubber-coated plastics elements, or the like. In some embodiments, the touch-protection device or means may be applied to a cylindrical part of a mating plug connector contact element.

Advantageously, it is proposed that the plug connector sealing element and the mating plug connector sealing element are formed with shaped elements, which ensure that the sealing elements seal the housing approximately flush. This means that a plug connector sealing clement, for example, has a circumferential groove in which a plug connector contact element engages as soon as a desired end position of the plug connector sealing element along the plug connector housing, more precisely, an end-side end face in the plug-in direction, is reached. This therefore means for the mating plug connector that a mating plug connector sealing element, for example, has a circumferential spring, or a stop, which butts against an inner side of the mating plug connector housing as soon as a desired end position of the mating plug connector sealing element along the mating plug connector housing, more precisely, an end-side end face in the mating plug-in direction, is reached. The mating plug connector touch-protection device or means fits approximately flush into the arrangement of the mating plug connector sealing element and the end face of the mating plug connector.

In one embodiment, the plug connector contact element may have a hollow-cylindrical plug-contact crimp region, a substantially hollow-cylindrical plug-contact contact region and a plug-contact spring receptacle within the plug-contact contact region. An electrical conductor is inserted in the plug-contact crimp region and pressed, i.e., crimped, there in an electrically contacting manner. The plug-contact contact region is provided for making contact with a corresponding mating-plug-contact contact region. The plug connector contact element may be in the form of a socket contact. The plug-contact contact region has slots along the longitudinal axis, which allow elastic deformation. The slots can be formed parallel to the longitudinal axis. Alternatively, the slots may be formed parallel to a longitudinal plane. Advantageously, the slots may be rotationally offset looking from the longitudinal axis in the plug-in direction. The plug-contact spring receptacle may be designed as a pin pointing in the plug-in direction. The outer diameter of the pin substantially corresponds to the inner diameter of the plug connector sealing spring. Alternatively, the plug-contact spring receptacle may be designed as a concentric groove, with the groove width substantially corresponding to the thickness of the plug connector sealing spring. In addition, the plug-contact spring receptacle may be designed as a concentric recess, with the radius of the recess substantially corresponding to the outer diameter of the plug connector sealing spring. The plug-contact spring receptacle ensures that the plug connector sealing spring is securely seated in the plug connector contact element, which ensures a safe displacement of the plug connector contact seal.

In one embodiment, the mating plug connector contact element may have a hollow-cylindrical mating-plug-contact crimp region and a substantially cylindrical mating-plug-contact contact region, wherein a mating-plug-contact touch-protection device or means receptacle, which is provided for receiving a mating plug connector touch-protection device or means, is formed on the end side of the mating-plug-contact contact region in the mating plug-in direction. In some embodiments, this mating plug connector touch-protection device or means may be pressed onto the mating plug connector contact element. Alternatively, the mating plug connector touch-protection device or means may be screwed into a mating-plug-contact touch-protection device or means receptacle in the form of a thread. There is also an integrally bonded connection, for example by adhesive bonding, of the mating-plug-contact touch-protection device or means onto or at the mating plug connector touch-protection device or means receptacle.

In an alternative embodiment, the mating plug connector contact element may have a hollow-cylindrical mating-plug-contact crimp region and a substantially hollow-cylindrical mating-plug-contact contact region, wherein a mating-plug-contact touch-protection-device or means receptacle, which is provided for receiving a mating plug connector touch-protection device or means, is formed on the end side of the mating-plug-contact contact region in the mating plug-in direction. In some embodiments, this mating plug connector touch-protection device or means may be pressed onto the mating plug connector contact element. Alternatively, the mating plug connector touch-protection device or means may be screwed into a mating-plug-contact touch-protection device or means receptacle in the form of a thread. Furthermore, there is also an integrally bonded connection, for example by adhesive bonding, of the mating-plug-contact touch-protection device or means onto or at the mating plug connector touch-protection device or means receptacle.

In one embodiment, the mating plug connector contact element may have at least one mating-plug-contact pin element within the hollow-cylindrical mating-plug-contact contact region, wherein a corresponding plug connector contact element fits in an electrically contacting manner between the mating-plug contact region and the mating-plug-contact pin element. In order to use such a form of contact for harsh working environments sensibly and safely, it is furthermore proposed that transfer spring elements are used for contacting mating plug connector contact element and plug connector contact element. For this purpose, annular spiral springs are often used in the prior art. Alternatively, spring-loaded, ring-like contact straps may be used.

In one embodiment, the plug connector housing may be formed in such a way that it displaces the mating plug connector contact seal during a plug-in operation. In this way, a secure plug-in operation of plug connector and mating plug connector is ensured, wherein the plug connector housing relieves the plug connector contact element of load in such a way that the force for displacing the mating plug connector contact seal acts on the plug connector housing, in order to prevent there possibly being damage to the plug connector contact element.

In one embodiment, the mating plug connector touch-protection device or means may be formed in such a way that it displaces the plug connector contact seal during a plug-in operation. In this way, a secure plug-in operation of plug connector and mating plug connector is ensured, wherein the mating plug connector touch-protection device or means protects the mating plug connector contact element in such a way that the force for displacing the plug connector contact seal from the mating plug connector touch-protection device or means is in action, as a result of which possible damage to the mating plug connector contact element is prevented.

In one embodiment, the plug connector contact element may be substantially designed as a socket contact and the mating plug connector contact element may be substantially designed as a pin contact, or vice versa. A pin contact in this connection may also be formed as a pin contact with a concentric contact sleeve, with a contact connection being able to be made by this embodiment. The socket contact can be connected in this way in its interior by the pin contact element in an electrically conductive manner, while at the same time an outer contact connection is made by the concentric contact sleeve.

In one embodiment, in the plug-in direction on the end side of the plug-contact contact region, the plug connector contact element may have a plug-contact contact shape, which ensures that the plug connector contact element makes contact with the mating plug connector contact element. Advantageously, a plug-contact contact shape may be in the form of an inwardly directed, circumferential bead. The plug connector contact element, which is in some embodiments in the form of a socket, ideally has slots which run on the longitudinal side and allow elastic deformation of the plug-contact contact region, as a result of which the plug-contact contact shape is particularly advantageously used for ensuring the electrical contact connection.

In one embodiment, the plug connector may have a locking shape and the mating plug connector may have a locking mechanism corresponding to the locking shape, or vice versa, wherein the locking mechanism is triggered in a locking manner by a first push in the plug-in direction. Push locking of this type is particularly suitable for a self-sealing solution. Solutions which are locked and released in terms of push and pull are particularly preferred. In this manner, the push movement for the locking, the contact seals, that is, the plug connector contact seal and the mating plug connector contact seal, can be displaced from the respective counterparts, that is, the plug connector housing and the mating plug connector touch-protection device or means such that an electrical contact connection of the plug connector contact element and the mating plug connector contact element takes place. At the same time, the locking mechanism locks the plug connector to the mating plug connector in the contacting position. A release mechanism, often designed as an unlocking sleeve in known solutions, releases the locking such that the plug connector can be disconnected from the mating plug connector. The sealing springs, i.e., the plug connector sealing spring and the mating plug connector sealing spring, ensure that the contact seals are returned again into the respective sealing position. Locking mechanisms of this type are also referred to in the prior art as “push-pull locking.”

In one embodiment, the locking mechanism may be released from the locking shape by a second push in the plug-in direction. In other words, the embodiment locks upon a first push, as described above, and, upon a renewed, second push, the locking is released such that the plug connector can be disconnected from the mating plug connector. In the prior art, locking of this type is also referred to as “ballpoint pen locking” or “push-push locking.”

Embodiments of the present disclosure provide a single-pole plug connector, having a plug connector housing and a plug connector contact element arranged in the plug connector housing, wherein the plug connector contact element has a plug contact crimp region on the end side counter to the plug-in direction and a plug-contact contact region on the end side in the plug-in direction, wherein the plug-contact contact region is assigned a plug connector contact seal, which is displaced by a corresponding mating plug connector during a plug-in operation. A plug connector of this type has the advantage that it is simple and robust compared to a corresponding mating plug connector with locking mechanism. In the region of agricultural environments, construction environments or comparably harsh environments, it may be of particular advantage if an implement which has to be supplied with electrical power has an electrical connection, which is designed in a simple manner. A corresponding mating plug connector may conventionally be somewhat more complex, since it can be designed as an attachment housing, and the more complex design can be introduced in a generator, a tractor, a lorry, a wheel loader, an excavator, or a similarly robust working machine. Therefore, it is proposed that the plug connector, as previously described in the description of the plug connector system, is provided with a locking shape, while the mating plug connector has a more complex structure, such as a locking mechanism, described previously in the description of the plug connector system.

In one embodiment, the plug connector contact element at or in the plug connector contact region may have a plug-contact spring receptacle, which is formed for receiving a plug connector sealing spring and wherein the plug connector contact seal interacts with the plug contact sealing spring. In this way, simple and effective sealing of the plug connector against foreign media is achieved, wherein the seal, or a sealing cap, in this case makes it possible for the plug connector contact seal not to be readily lost, damaged or stolen. The plug connector sealing spring moves the plug connector contact seal in the plug-in direction as soon as mating plug connector and plug connector are separated, thus resulting in an advantageous, quasi-permanent sealing of the plug connector as soon as the plug connector is not in use.

Embodiments of the present disclosure provide a single-pole mating plug connector, having a mating plug connector housing and a mating plug connector contact element arranged in the mating plug connector housing, wherein the mating plug connector contact element has a mating-plug-contact crimp region on the end side counter to the mating plug-in direction and a mating-plug-contact contact region on the end side in the mating plug-in direction, wherein the mating-plug-contact contact region is assigned a mating plug connector contact seal, which is displaced by a corresponding plug connector during a plug-in operation. A mating plug connector of this type can advantageously be designed as an attachment housing such that it can be more complex compared to a corresponding plug connector with a locking shape, since the more complex structure can be introduced, for example, in the interior of a generator, a tractor, a lorry, an excavator, a wheel loader or a similarly robust working machine. It therefore seems particularly expedient that the mating plug connector, as previously described in the description of the plug connector system, is designed with a locking mechanism, while the plug connector uses a robust and simple design.

In one embodiment, the mating plug connector contact clement is held by a mating plug connector contact receptacle in the mating plug connector housing. The mating plug connector contact receptacle has a mating-plug-contact spring receptacle, which is formed at or in the mating plug connector contact receptacle and is provided for receiving a mating plug connector sealing spring, wherein the mating plug connector contact seal interacts with the mating-plug-contact sealing spring. The mating plug connector contact receptacle may be screwed to the mating plug connector housing for fastening the mating plug connector contact element, wherein the mating plug connector housing may have a stop to fix the mating plug connector contact element in a desired position. Advantageously, the mating plug connector contact receptacle is formed with latching elements which interact with corresponding latching devices or means of the mating plug connector housing, or vice versa, such that the mating plug connector contact element is held by simple latching in the mating plug connector housing. Here, the mating plug connector contact receptacle is advantageously provided with a circumferential flange, which is arranged between the interior of the mating plug connector housing and the outer circumference of the mating plug connector contact receptacle and thus acts as a mating-plug-contact spring receptacle. Alternatively, it may be appropriate to design the mating-plug-contact spring receptacle as a concentric, circumferential groove in an outer configuration of the mating plug connector contact receptacle, into which the mating plug connector sealing spring fits.

A method for producing a plug connection is provided, wherein a plug connector system has a plug connector with a plug connector contact seal, and wherein a mating plug connector has a mating plug connector contact seal. The plug connector displaces a mating plug connector contact seal during a plug-in operation, wherein the mating plug connector displaces a plug connector contact seal during a plug-in operation, wherein the displaced plug connector contact seal releases a plug connector contact element, and wherein the displaced mating plug connector contact seal releases a mating plug connector contact element.

Embodiments of the present disclosure provide a single-pole plug connector system including a plug connector and a mating plug connector, wherein the plug connector has a plug connector housing, a plug connector contact seal and a plug connector contact element, and wherein the mating plug connector has a mating plug connector housing, a mating plug connector contact seal, a mating plug connector touch-protection device or means and a mating plug connector contact element. In this case, the plug connector has a locking shape and the mating plug connector has a locking mechanism, wherein the locking mechanism interacts with the locking shape, and wherein the locking mechanism is actuated in the plug-in direction by an actuating push, wherein the actuating push brings the locking mechanism into engagement with the locking shape, as a result of which the plug connector is locked to the mating plug connector in an electrically conductive connection, and wherein a release push in the plug-in direction releases the locking mechanism from the locking shape. The mating plug connector may be provided with a locking shape, while the plug connector may be equipped with a locking mechanism. In other words, the terms “plug connector” and “mating plug connector” can be used essentially synonymously and are used primarily for improved readability.

The term “locking shape” means a shaped feature on the plug connector that is designed to be brought into engagement with a locking mechanism to secure a connection between a plug connector and a mating plug connector against unintentional release of the connection. Locking shapes provided may be grooves, springs, latching tabs, latching hooks, bolts, bayonet locking grooves, bayonet locking bolts, cams, cam tracks, extensions, or combinations of the above options. Other shapes are known to a person skilled in the art with that sort of mind and can of course be transferred. A locking shape designed as a circumferential groove is particularly preferred.

A conceivable “locking mechanism” is any type of device which can be brought into engagement with previously described locking shapes such that a plug connector and a mating plug connector are secured to each other in the plugged-in position against inadvertent disconnection of the electrical connection.

“Actuating push” means a plug-in operation, which may take place until a physical stop. The physical stop can be produced by limiting a spring travel of a plug connector sealing spring, or a mating plug connector sealing spring, or both. The actuating push is thus a push movement during a plug-in operation as far as a stop, the locking mechanism engaging in a locking shape.

A “release push” refers to a disconnection operation, i.e., a renewed, second push, preferably as far as a physical stop. A mechanism in the locking mechanism is changed from a blocking position into an open position by the release push such that the locking mechanism no longer engages in a fixing manner in the locking shape. After this release push, plug connector and mating plug connector can be separated from each other by a simple pulling movement counter to the plug-in direction. Locking mechanisms which lock at a first push in the plug-in direction, i.e., an actuating push, and release the locking at a second push in the plug-in direction, i.e., a release push, are also referred to as “push-push locking.”

In one embodiment, the locking mechanism may have a locking changer, a locking housing, a rotation stop, and a locking spring.

The term “locking changer” means a part of the locking mechanism that, in combination with the locking housing, allows a change between locked and open locking mechanism. For this purpose, it is proposed to design the locking changer as a rigid, i.e., non-rotational, movable element, for example as a sleeve-shaped, i.e., substantially hollow-cylindrical component, which may be arranged in a superordinate housing. The locking housing butts against the locking changer, or engages in or penetrates the locking changer, or a combination of both.

The “rotation stop” should be formed substantially comparably to the locking changer as a hollow-cylindrical, rigid, i.e., non-rotationally movable element, which may be arranged in a superordinate housing.

In one embodiment, the locking changer may have an alternating toothing, and the locking housing has a housing alternating toothing corresponding to the alternating toothing, wherein a locking spring forces the locking housing in the direction of the locking changer. In some embodiments, the alternating toothing and the housing alternating toothing may be formed parallel to the central axis of the mating plug connector, that is, the toothing in each case facing the end face in the longitudinal direction.

In one embodiment, the rotation stop may have a rotational toothing, and the locking housing may have a housing rotational toothing corresponding to the rotational toothing, wherein a push movement counter to the locking spring brings the rotational toothing into engagement with the housing rotational toothing in such a manner that the locking housing is forced into a partial rotation. The partial rotation is predetermined by a tooth width of the rotational toothing or the housing rotational toothing. In some embodiments, the rotational toothing and the housing rotational toothing may be formed parallel to the central axis of the mating plug connector, that is, the toothing in each case facing the end face in the longitudinal direction.

In one embodiment, the locking housing may have a spring stop on which the locking spring engages such that the locking housing is forced in the direction of the locking changer. A locking housing is removed from a locking changer by a first plugging-in of plug connector and mating plug connector. In this case, the housing rotational toothing and the rotational toothing engage with each other in such a way that the locking housing is forced to partially rotate. This partial rotation causes alternating toothing and housing alternating toothing to pass into an orientation offset with respect to each other. If the locking spring then brings together the alternating toothing and the housing alternating toothing again, the toothings mesh in such a way that a complete change of rotation takes place.

In one embodiment, the locking changer may be assigned a locking cage, which alternately forces locking elements located in the locking cage when the locking housing changes in rotation into a locking shape and releases them again. A locking cage should be understood as meaning both an individual component and an assembly including a plurality of components, which are essentially separated from each other and together carry out the function.

Another method includes a plug connector provided with a locking shape, and the mating plug connector is equipped with a locking mechanism, wherein the locking mechanism is brought into engagement with the locking shape by a first actuating push in the plug-in direction or mating plug-in direction, i.e., secures the plug connector in an electrically contacting manner in the mating plug connector, and, by a second actuating push in the plug-in direction or mating plug-in direction, causes the locking mechanism to release the locking shape such that the plug connector can be removed from the mating plug connector.

In one embodiment, a single-pole plug connector system is provided having a plug connector and a mating plug connector, wherein the plug connector system is assigned a locking mechanism, and wherein the locking mechanism is assigned a tear-off safety device, which allows the locking mechanism to be released in the event of mechanical overload, such as by pulling counter to the plug-in direction.

In one embodiment, the tear-off safety device releases the locking mechanism of the plug connector system, in the event of mechanical overload occurring, in such a way that plug connector and mating plug connector are essentially functionally separated from each other for further use. In some embodiments, the triggered tear-off safety device adjusts the locking mechanism in such a way that a new plug-in operation is possible without further preparation and/or resetting of the locking mechanism.

In one embodiment, the tear-off safety device may have a safety device energy store, such as in the form of a spring element. The tear-off safety device allows a locking cage to deviate from the locking housing and/or from the locking changer in the deviation direction, wherein the locking elements release a locking shape, thus allowing separation of plug connector and mating plug connector.

In one embodiment, the tear-off safety device at the plug-side end of the locking mechanism may have a release sleeve which fixes the locking cage in the intended position on the locking mechanism and is held in this position by a safety device energy store.

In one embodiment, the safety device energy store may be adjusted in its triggering force with a safety device calibration device or means. For this purpose, the safety device calibration device or means is substantially in the form of a flange with an internal thread, is arranged at a cable-side end of the locking mechanism, and is changeable by the internal thread in its position along the locking mechanism by an external thread located thereon.

In one embodiment, the safety device energy store may be arranged between the release sleeve and the locking housing and may be in the form of a circumferential spring. This design thus introduces the use of a safe, but cost-effective and robust option for flexible implementation of the tear-off safety device described herein.

Alternatively, in one embodiment, the safety device energy store may be in the form of a circumferential spiral spring ring, may be arranged in a first groove in the locking mechanism, and engages in a corresponding second groove in the release sleeve. For this purpose, it is possible to use obliquely running spiral springs, which are also known in the prior art as Bal Seal springs. When the tension load is defined, the safety device energy store in the form of a spiral spring ring is deformed counter to the deviation direction and thus releases the release sleeve in the push-in direction.

### BRIEF DESCRIPTION OF THE SEVERAL VIEWS OF THE DRAWINGS

The present disclosure is illustrated in the drawings and will be explained in more detail below.

FIG. 1 shows a perspective illustration of a plug connector.

FIG. 2 shows a perspective illustration of a mating plug connector.

FIG. 3 shows a cross-sectional illustration along the longitudinal axis of a plug connector system.

FIG. 4 shows a cross-sectional illustration along the longitudinal axis of a plugged-in plug connector system.

FIG. 5 shows a lateral illustration of a plug connector system with a locking mechanism in the initial position.

FIG. 6 shows a lateral illustration of a plug connector system with a locking mechanism in the plugged-in position.

FIG. 7 shows a perspective sectional illustration along the longitudinal axis of a plug connector system with a tear-off safety device in the locked state.

FIG. 8 shows a perspective sectional illustration along the longitudinal axis of a plug connector system with a tear-off safety device during a tear-off release operation.

The figures contain partially simplified, schematic illustrations. To some extent, identical reference signs are used for elements that are similar but might not be identical. Different views of the same elements may be drawn to different scales. Directional indications such as “left,” “right,” “top” and “bottom” should be understood with reference to the figure in question and may vary in the individual illustrations in relation to the object illustrated.

### DETAILED DESCRIPTION

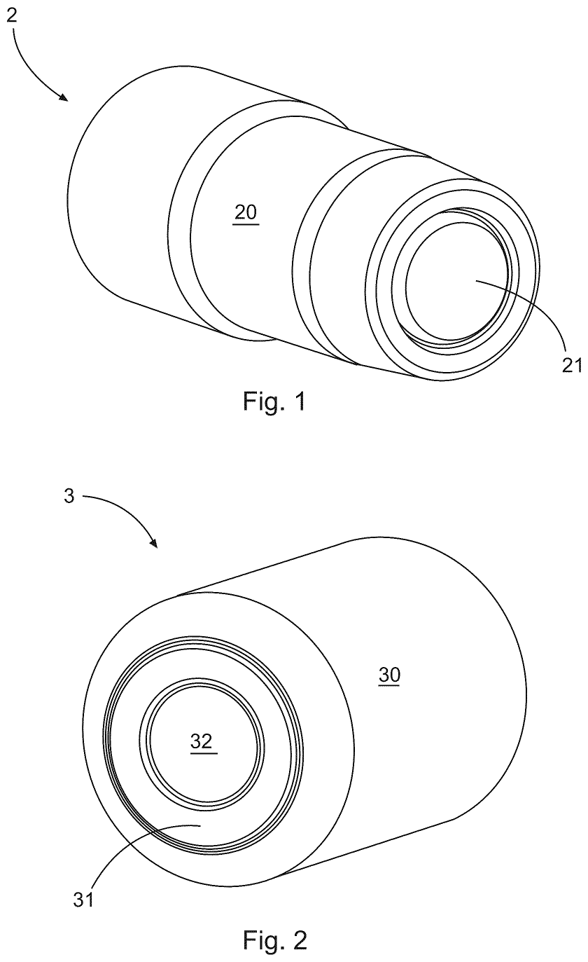

FIG. 1 shows a plug connector 2 according to an embodiment of the present disclosure. In the illustration, a plug connector housing 20 and a plug connector contact seal 21 arranged on the plug-side end face can be seen.

FIG. 2 shows a mating plug connector 3 in a design corresponding to the plug connector 2. The illustration shows a mating plug connector housing 30, a mating plug connector contact seal 31 arranged on the mating-plug-side end face, and a mating plug connector touch-protection device or means 32 in the concentrically annular mating plug connector contact seal 31.

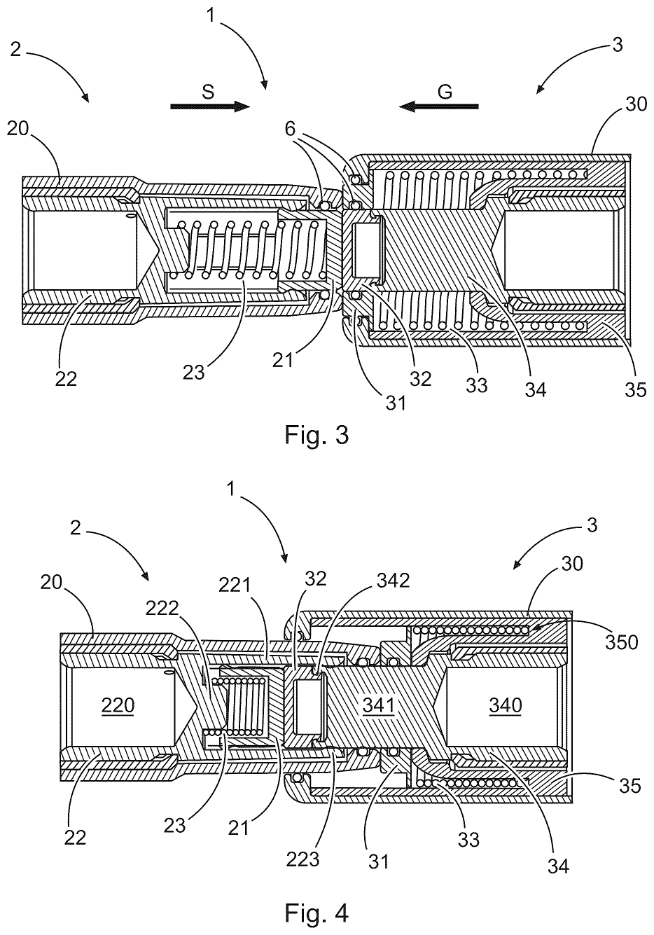

FIG. 3 shows a longitudinal section of a plug connector system 1, according to an embodiment of the invention, wherein the structures of the plug connector 2 and of the mating plug connector 3 are illustrated. An unplugged-in state of plug connector 2 and mating plug connector 3 is first of all shown, wherein the plug connector 2 is connected to the mating plug connector 3 in such a way that a plug-in operation can take place. In this case, the plug-side end face of the plug connector 2 is guided to the mating-plug-side end face of the mating plug connector 3 such that the plug connector contact seal 21 lies opposite the mating plug connector touch-protection device or means 32. The end face of the plug connector housing 20 butts here against the mating plug connector contact seal 31. Furthermore, a mating plug connector contact element 34 is provided with a mating plug connector touch-protection device or means 32, which is substantially flush on the mating plug-in side with the mating plug connector housing 30. It is clear here that the mating plug connector touch-protection device or means 32 coincides with the plug connector contact seal 21 in such a way that the mating plug connector touch-protection device or means 32 is designed during a plug-in operation to displace the plug connector contact seal 21 in a mating plug-in direction G counter to a spring force of a plug connector sealing spring 23. Similarly, the plug connector housing 20 is designed to displace the concentric mating plug connector contact seal 31 in a plug-in direction S counter to a force applied by a mating plug connector sealing spring 33. A structure of a plug connector 2 described herein is illustrated. A spring-loaded plug connector contact seal 21, a plug connector contact element 22 and the plug connector sealing spring 23 arranged in the plug connector contact element 22 and interacting with the plug connector contact seal 21 are arranged within the plug connector housing 20. In this case, a plug connector sealing spring 23 forces the plug connector sealing element 21 in the plug-in direction S such that it ends on the end face approximately flush with the plug connector housing 20. It is proposed to provide a sealing clement 6 in a shape and/or recess provided for this purpose in the plug-in-side end of the plug connector housing 20. In the unplugged-in state illustrated, the sealing element 6 seals the interior of the plug connector housing 20 and thus the plug connector contact element 22 against foreign media. The sealing clement 6 can be designed as a simple O-ring. In some embodiments, the sealing clement may be designed as a lamellar seal, or lamellar sealing ring, wherein the lamellae face in the direction of the plug connector contact seal 21. The structure of the mating plug connector 3 is also disclosed. The mating plug connector housing 30 receives at least one mating plug connector contact seal 31, which ends on the mating plug-in side approximately flush with the mating plug connector housing 30, and also approximately flush with a mating plug connector touch-protection device or means 32. In this case, the mating plug connector contact seal 31 is pushed in the mating plug-in direction G by a mating plug connector sealing spring 33, where at least one sealing clement 6 in a form provided for this purpose in the mating plug connector housing 30 directed inwardly seals the mating plug connector contact seal 31 in the unplugged-in state against foreign media. Furthermore, it is proposed that the mating plug connector contact seal 31 is equipped with a sealing element 6 facing inward, in the direction of the mating plug connector touch-protection device or means 32. Alternatively, it is proposed that the mating plug connector touch-protection device or means 32 has an outwardly directed sealing element 6. The mating plug connector sealing spring 33 and a mating plug connector contact element 34 are held in the mating plug connector housing 30 by a mating plug connector contact receptacle 35.

FIG. 4 shows a longitudinal section of a plug connector system 1 described herein, wherein the structures of the plug connector 2 and of the mating plug connector 3 in a state plugged together are illustrated. It becomes clear here how a plug connector 2 enters into engagement in a mating plug connector 3. It becomes clear how the plug connector contact element 22 is brought into electrically conductive connection with the mating plug connector contact element 34. An electrical conductor, conventionally a cable, is introduced into a plug-contact crimp region 220, where it is pressed or crimped. Arranged on the end face in the plug-in direction S, the plug connector contact element 22 has a plug-contact contact region 221, which is designed to be connectable to a mating plug connector contact element 34. The design shown shows the plug connector contact element 22 as a socket contact, the plug-contact contact region 221 is therefore substantially hollow-cylindrical. On the end face facing in the plug-in direction S, the plug-contact contact region 221 is provided with a plug-contact contact shape 223. The design shown provides a bead which faces in the direction of the longitudinal axis and better contacts the mating plug connector contact element 34. Inside the plug-contact contact region 221, which is in the form of a hollow cylinder, there is a plug-contact spring receptacle 222. The plug-contact spring receptacle 222 is designed to receive the plug connector sealing spring 23. In some embodiments, the plug-contact spring receptacle 222 may be designed as a bolt-like extension. The outer diameter of the extension corresponds to the inner diameter of the plug connector sealing spring 23. Alternatively, the plug-contact spring receptacle 222 may be designed as a concentric groove into which the plug connector sealing spring 23 fits or can be inserted. Within the mating plug connector 3, the mating plug connector contact element 34 is held by a recess or a holding shape in the mating plug connector housing 30. The mating plug connector contact receptacle 35 still has a mating-plug-contact spring receptacle 350. Facing counter to the mating plug-in direction G, the mating plug connector contact element 34 is designed with a mating-plug-contact crimp region 340, in which an electrical conductor, such as a cable, is inserted and pressed therein, or crimped. The mating plug connector contact element 34 has a mating-plug-contact contact region 341. The mating-plug-contact contact region 341 is designed as a pin contact, which can be inserted into the plug connector contact element 22, which is designed as a socket contact. The mating plug connector contact element 34 ends facing in the mating-plug-in direction G with a mating plug connector touch-protection device or means 32, which is held by a mating-plug-contact touch-protection device or means receptacle 342 on the mating plug connector contact element 34. In one embodiment, the mating-plug-contact touch-protection device or means receptacle 342 is designed as a thread, which interacts with a corresponding thread of the touch-protection means 32. In some embodiments, the mating-plug-contact touch-protection device or means receptacle 342 may be designed as a latching element and/or latching bead, into which the mating plug connector touch-protection device or means 32 is latched and/or pressed, or can be pressed thereon.

FIG. 5 shows a plug connector system 1 having a plug connector 2 and a mating plug connector 3, wherein the mating plug connector 3 furthermore has a locking mechanism 4, which can engage in a locking manner in a locking shape 200 integrally formed on the plug connector 2. This shows an unlocked, unplugged-in state of the plug connector system 2.

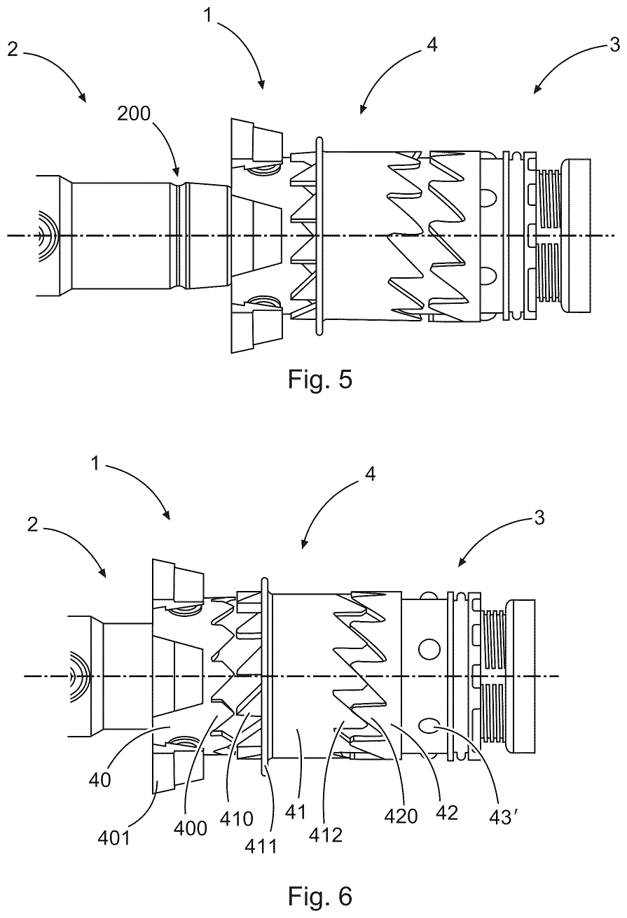

In FIG. 6, the functioning of the locking mechanism 4 is explained in more detail. The plug connector 2 is inserted into the mating plug connector 3, as a result of which a locking housing 41 is guided away from a locking changer 40 in the plug-in direction S. The locking housing 41 is guided in the direction of a rotation stop 43. This removes a housing alternating toothing 410 from an alternating toothing 400. During this time, a housing rotational toothing 412 is brought into engagement with a rotational toothing 420. In this manner, the mutually offset arrangement and configuration of the alternating toothing 400, the housing alternating toothing 410, the housing rotational toothing 412 and the rotational toothing 420, the locking housing 41 is rotated in such a way that locking elements 43 arranged in the locking changer 40 are brought into engagement with a locking cage 401. As a result, the plug connector 2 can no longer be unintentionally separated from the mating plug connector 3. When the plug connector 2 is pushed again in the plug-in direction S, this rotational movement is carried out again such that the locking elements 43 are no longer in engagement with the locking cage 401, and therefore the plug connector 2 can be separated from the mating plug connector 3. So that the locking housing 41 can be moved back against the locking changer 40 after a push movement in the plug-in direction S, the locking housing 41 has a spring stop 411. A locking spring 44 can act upon this spring stop 411 to force the locking housing 41 in the mating plug-in direction G against the locking changer 40. The housing rotational toothing 412 and the rotational toothing 420 are designed in such a way that a half locking rotation is carried out when fully engaged, while the housing alternating toothing 410 and the alternating toothing 400 complete this half locking rotation. The locking rotation here means the rotation of the locking housing 41, which is necessary to bring the locking elements 43 into engagement with a locking cage 401 and/or to release this engagement.

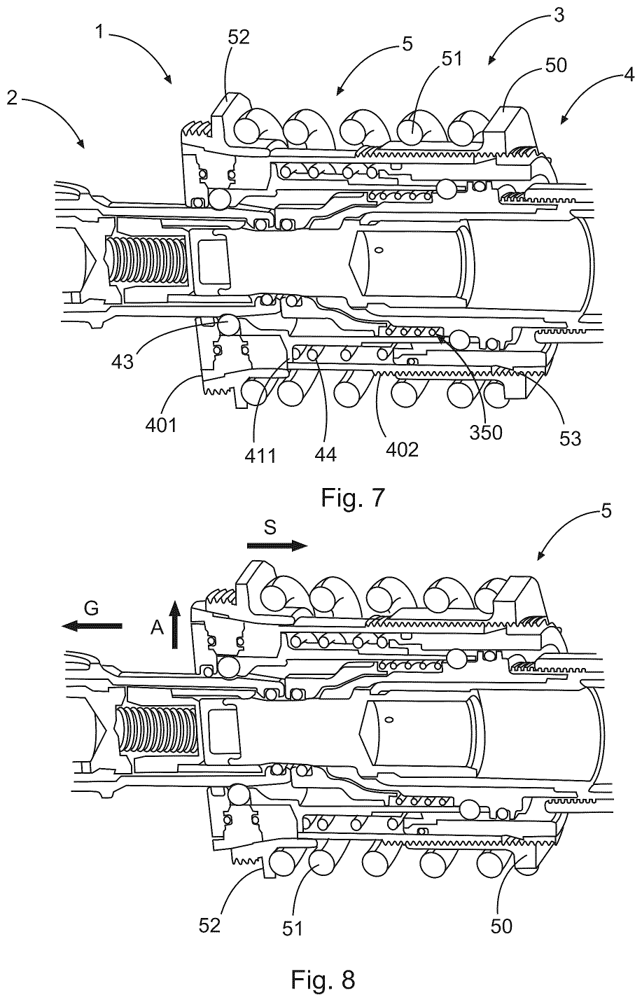

One embodiment is illustrated in FIGS. 7 and 8. In this case, a plug connector system 1 is provided with a tear-off safety device 5. This tear-off safety device 5 is intended to make it possible that, in the event of mechanical overload, such as by pulling on a connected cable or cable harness, the locking mechanism 4 can release the locking of plug connector 2 and mating plug connector 3 before the plug connector 2 or the mating plug connector 3 or the cable, or the cable harness is (possibly permanently) damaged. The tear-off safety device 5 is realized with a safety device calibration device or means 50, a safety device energy store 51 and a release sleeve 52. In this case, the release sleeve 52 is inserted in the housing wall of a working machine. In FIGS. 5 and 6, the release sleeve 52 is designed with an external thread, which can be brought into engagement with said housing wall of the working machine. The release sleeve 52 and the safety device calibration device or means 50 each have a flange and/or shapes, as shown, which allow it to remain in engagement with the safety device energy store 51. In one embodiment, the safety device calibration device or means 50 has an internal thread 53, which interacts with an external thread 402 of the locking mechanism 4 such that the storage size of the safety device energy store 51 which is used can be adjusted. This means that the energy store 51, which is designed as a spiral spring, can be adjusted in its spring force by the safety device calibration device or means 50 in such a way that the tear-off safety device 5 triggers at a desired set force. Triggering means that, with a pull loading in the mating plug-in direction G, the plug connector 2, which is connected in a locked manner to the mating plug connector 3, disengages the mating plug connector 3 together with the locking mechanism 4 from the tear-off safety device 5. By removing the locking cage 401 from the release sleeve 52 fixing the locking cage 401, the locking cage can deviate in the deviation direction A. In some embodiments, the deviation may be limited by a form lock or elastically in order to prevent loss of the locking cage 401. In this manner, the deviation, for example in the form of stretching of elastic components, the locking element 43 is released such that the locking shape 200 of the plug connector 2 becomes free. In other words, the locking element 43 no longer engages in the locking shape 200. The underlying pulling movement in the mating plug-in direction G releases the plug connector 2 from the mating plug connector 3. Subsequently, a push in the plug-in direction S on a stop element, for example, a flange on the safety device calibration device or means 50, the safety device energy store 51 forces the mating plug connector 3 back into the predetermined position, as a result of which the release sleeve 52 moves the locking cage 401 and the locking element 43 arranged below it back into the original position. The locking elements 43 are moved into a non-latching position such that the mating plug connector 3 and the locking mechanism 4 are again located in the initial position and are thus ready for a new plug-in operation.

Even though various aspects or features of the invention are respectively shown in combination in the figures, it is clear to a person skilled in the art that—unless otherwise stated—the combinations shown and discussed are not the only ones possible. In particular, mutually corresponding units or complexes of features from different exemplary embodiments can be interchanged with one another.

German patent application no. 10 2023 127 143.1 filed Oct. 5, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A single-pole plug connector system, comprising:
a plug connector; and
a mating plug connector,
wherein the plug connector has a plug connector housing, a plug connector contact seal, and a plug connector contact element,
wherein the mating plug connector has a mating plug connector housing, a mating plug connector contact seal, a mating plug connector touch-protection device, and a mating plug connector contact element,
wherein the plug connector has a locking shape and the mating plug connector has a locking mechanism, wherein the locking mechanism interacts with the locking shape, and wherein the locking mechanism is actuated in a plug-in direction by a push movement, wherein a first actuating push brings the locking mechanism into engagement with the locking shape, as a result of which the plug connector is locked to the mating plug connector in an electrically conductive connection, and wherein a second actuating push releases the locking mechanism from the locking shape.

2. The plug connector according to claim 1, wherein the locking mechanism has a locking changer, a locking housing, a rotation stop, and a locking spring.

3. The plug connector according to claim 2, wherein the locking changer has an alternating toothing, and the locking housing has a housing alternating toothing corresponding to the alternating toothing, wherein a locking spring forces the locking housing in a direction of the locking changer.

4. The plug connector according to claim 2, wherein the rotation stop has a rotational toothing, and the locking housing has a housing rotational toothing corresponding to the rotational toothing, wherein a push movement counter to the locking spring brings the rotational toothing into engagement with the housing rotational toothing in such a manner that the locking housing is forced into a rotation predetermined by at least one of the tooth widths of the rotational toothing or the housing rotational toothing.

5. The plug connector according to claim 2, wherein the locking housing has a spring stop on which the locking spring engages such that the locking housing is forced in the direction of the locking changer.

6. The plug connector according to claim 4, wherein the locking housing is configured to receive at least one locking element, wherein the locking housing moves the locking element in an alternating manner during rotation between a locking cage and a free position within either the locking changer or the mating plug connector housing.

7. The plug connector according to claim 6, wherein the locking cage forces the locking element into the locking shape, as a result of which the locking of plug connector and mating plug connector is achieved, and the free position within the locking changer allows the locking element to deviate in a deviation direction releasing the locking of the plug connector and mating plug connector.

8. A method for producing a single-pole electrical plug connector, having a plug connector system according to claim 1,
wherein a plug connector is provided with a locking shape, and the mating plug connector is equipped with a locking mechanism, wherein the locking mechanism is brought into engagement with the locking shape by a first actuating push in a plug-in direction, and, by a second actuating push in the plug-in direction, causes the locking mechanism to release the locking shape such that the plug connector can be removed from the mating plug connector.

9. A single-pole plug connector system, comprising:
a plug connector; and
a mating plug connector,
wherein the plug connector has a plug connector housing, a plug connector contact seal, and a plug connector contact element,
wherein the mating plug connector has a mating plug connector housing, a mating plug connector contact seal, a mating plug connector touch-protection device, and a mating plug connector contact element, wherein the plug connector has a locking shape, and the mating plug connector has a locking mechanism, and
wherein the locking mechanism is assigned a tear-off safety device, which allows the locking mechanism to be released in an event of mechanical overload, by pulling counter to a plug-in direction.

10. The plug connector according to claim 9, wherein the tear-off safety device releases the locking mechanism of the plug connector system, in the event of mechanical overload occurring, in such a way that plug connector and mating plug connector are functionally separated from each other.

11. The plug connector according to claim 9, wherein the tear-off safety device has a safety device energy store in the form of a spring element, which allows a locking cage to deviate from a locking housing or from a locking changer or from both in a deviation direction, wherein a locking element releases the locking shape, allowing separation of the plug connector and mating plug connector.

12. The plug connector according to claim 9, wherein the tear-off safety device at a plug-side end of the locking mechanism has a release sleeve which fixes the locking cage in an intended position on the locking mechanism and is held in the intended position by the safety device energy store.

13. The plug connector according to claim 12, wherein the safety device energy store is configured to be adjusted in a triggering force of the safety device energy store with a safety device calibration device by the safety device calibration device being substantially in the form of a flange with an internal thread being arranged at a cable-side end of the locking mechanism, and being changeable by the internal thread in a position along the locking mechanism by an external thread located thereon.

14. The plug connector according to claim 12, wherein the safety device energy store is arranged between a release sleeve and the locking housing and is formed having at least one circumferential spring, or spiral spring, or disc spring, or a combination thereof.

15. The plug connector according to claim 12, wherein the safety device energy store is in the form of a circumferential spiral spring ring, is arranged in a first groove or first holding shape in the locking mechanism or in a housing surrounding the tear-off safety device, and engages in a corresponding second groove or second holding shape in the release sleeve.

16. The plug connector according to claim 15, wherein when a tension load is defined, the safety device energy store in the form of a spiral spring ring is deformed counter to a deviation direction and releases the release sleeve in a push-in direction, or the locking changer, or allows the locking housing to exit from the release sleeve in a mating plug-in direction such that the locking cage releases the locking elements in the deviation direction.
